(19) United States
(12) Patent Application Publication
(10) Pub. No.: US 2022/0121728 A1
(43) Pub. Date: Apr. 21, 2022

(54) NONNEGATIVE MATRIX FACTORIZATION OPTIMIZATION APPARATUS, NONNEGATIVE MATRIX FACTORIZATION OPTIMIZATION METHOD, AND PROGRAM

(71) Applicant: NIPPON TELEGRAPH AND TELEPHONE CORPORATION, Tokyo (JP)

(72) Inventors: Kenta NIWA, Tokyo (JP); Noboru HARADA, Tokyo (JP)

(73) Assignee: NIPPON TELEGRAPH AND TELEPHONE CORPORATION, Tokyo (JP)

(21) Appl. No.: 17/428,263

(22) PCT Filed: Jan. 23, 2020
(86) PCT No.: PCT/JP2020/002206

§ 371 Date: Aug. 3, 2021

(30) Foreign Application Priority Data
Feb. 5, 2019 (JP) 2019-018425

(51) Int. Cl. G06F 17/16; G06F 17/18

(52) U.S. Cl. CPC G06F 17/16; G06F 17/18

(57) ABSTRACT

Provided is a non-negative matrix factorization technology of achieving high-speed and stable convergence. A non-negative matrix factorization optimization device includes an optimization unit configured to optimize a non-negative matrix {A, B}, which is factorization of a matrix Z satisfying Z=AB^{T}, by inputting a measurement matrix Y, where Y represents a non-negative measurement matrix representing a measurement signal or measurement data, and Z represents a non-negative matrix constructing the measurement matrix Y, and a cost function J to be used for optimization by the optimization unit is defined by an expression of J(A, B)=G(Y∥AB^{T})+H_{A}(A)+H_{B}(B), where G represents a loss term, H_{A} represents a normalization term for the matrix A, and H_{B} represents a normalization term for the matrix B, and the optimization unit optimizes the matrix {A, B} based on Bregman monotone operator splitting.

### TECHNICAL FIELD

The present invention relates to a non-negative matrix factorization technology of representing a non-negative matrix as a product of two non-negative matrices.

### BACKGROUND ART

A problem (non-negative matrix factorization problem) of using a non-negative matrix (hereinafter referred to as “measurement matrix”) representing a measurement signal or measurement data to estimate a group of non-negative matrices potentially constructing the non-negative matrix is widely used. For example, a problem of inputting a sound spectrogram or an image and removing a noise mixed therein, or a problem (topic model) of inputting statistically aggregated data such as a questionnaire and decomposing and extracting user characteristics inherent therein is practically used gradually. Further, in such an application case, there is also an increasing number of scenes that require reduction of a processing time or real-time processing.

Now, first, the above-mentioned non-negative matrix factorization problem is formulated. The following rule of notation is introduced due to restriction of notation in specification. \hat{ } (caret) represents a superscript, and for example, x^{y\hat{ }z} represents the fact that y^{z} is a superscript of x. (underscore) represents a subscript, and for example, x^{y_z} represents the fact that y_{z} is a superscript of x. Further, the superscript ‘^{\hat{ }}’ or ‘^{˜}’ used as ^{\hat{ }}x or ^{˜}x for a certain character x is originally considered to be written right above ‘x’, but ^{\hat{ }}x or ^{˜}x is written in this specification.

It is assumed that a (non-negative) measurement matrix YϵR^{I×J} is constructed by a sum of a matrix ZϵR^{I×J} that can be subjected to non-negative matrix factorization and a matrix EϵR^{I×J} representing a noise. The non-negative matrix Z is, for example, a matrix representing a sound spectrogram from which a noise has been removed or an image from which a noise has been removed. Further, it is assumed that the non-negative matrix Z is represented by a product of two non-negative matrices {A, B} (AϵR^{I×K}, BϵR^{J×K}) as represented by the following expression.

[Math. 1]

Y=Z+E=AB^{T}+E (1-1)

K represents a sufficiently small constant, and K is preferred to be a value smaller than I and J. Further, T represents a transpose. The matrix {A, B} may also be referred to as “factorization coefficient matrix”.

A cost function J(A, B):R^{I×K}×R^{J×K}→R∪{−∞, +∞} is constructed by a sum of normalization terms H_{A} and H_{B} for a loss term G and the matrix {A, B}.

[Math. 2]

J(A,B)=G(Y∥AB^{T})+H_{A}(A)+H_{B}(B) (1-2)

The loss term G is used for measuring an error between two matrices (matrix Y and matrix AB^{T} in expression (1-2)). Further, the normalization terms H_{A} and H_{B} ensure that the matrix {A, B} is non-negative.

From the description given above, the problem to be solved is to estimate such a matrix {A, B} as to minimize the cost function J, and can be formulated by the following expression.

$$\begin{matrix}[ Math . 3 ] & \\ {inf}_{A \geq 0 , B \geq 0} J ( A , B ) & \text{(1-3)}\end{matrix}$$

The expression (1-3) represents an operation of estimating the non-negative matrix {A, B} that produces an infimum of the cost function J.

Now, a description is given in detail of the loss term and the normalization term. First, the loss term is described. Any closed proper convex function (hereinafter simply referred to as “convex function”) can be used for the loss term G. For example, the loss term G is represented by Bregman divergence (strictly convex function) in the following manner.

$$\begin{matrix}[ Math . 4 ] & \\ {G}_{Φ} ( Y ‖ {AB}^{T} ) = {Σ}_{i , j} ( Φ ( {y}_{ij} ) - Φ ( {z}_{ij} ) - ∇ Φ ( {z}_{ij} ) ( {y}_{ij} - {z}_{ij} ) ) & \text{(1-4)}\end{matrix}$$

For example, when a (continuously differentiable and strongly convex) strictly convex function ϕ^{(β)} represented by an expression (1-5) is used, β divergence represented by an expression (1-6) is obtained as a loss term G_{ϕ\hat{ }(β)}. The β divergence is one of loss terms frequently used in non-negative matrix factorization.

$$\begin{matrix}[ Math . 5 ] & \\ {Φ}^{( β )} ( z ) = \{ \begin{matrix}\frac{{z}^{( β + 1 )}}{β ( β + 1 )} - \frac{z}{β} + \frac{1}{β + 1} & ( β > 0 ) \\ z log ( z ) - z + 1 & ( β = 0 ) \\ z - log ( z ) - 1 & ( β = - 1 )\end{matrix} & \text{(1-5)} \\ {G}_{{Φ}^{( β )}} ( Y ‖ Z ) = \{ \begin{matrix}{Σ}_{ij} ( {y}_{ij} \frac{{y}_{ij}^{β} - {z}_{ij}^{β}}{β} - \frac{{y}_{ij}^{β + 1} - {z}_{ij}^{β + 1}}{β + 1} ) & ( β > 0 ) \\ {Σ}_{ij} ( {y}_{ij} log ( \frac{{y}_{ij}}{{z}_{ij}} ) - {y}_{ij} + {z}_{ij} ) & ( β = 0 ) \\ {Σ}_{ij} ( log ( \frac{{z}_{ij}}{{y}_{ij}} ) + \frac{{y}_{ij}}{{z}_{ij}} - 1 ) & ( β = - 1 )\end{matrix} & \text{(1-6)}\end{matrix}$$

This β divergence matches a Frobenius norm when β=1 is satisfied, matches a generalized KL divergence when β=0 is satisfied, or matches an Itakura-Saito distance when β=−1 is satisfied.

Next, the normalization term is described. Regarding the normalization term, it is necessary to at least ensure that the matrix {A, B} serving as variables is non-negative. For that purpose, for example, a non-negative barrier function that outputs 0 when all the components of a matrix are equal to or larger than 0, or outputs +∞ in other cases can be used to define the normalization term.

[Math. 6]

H_{A}(A)=Σᵢₖδ₍ₐ_{ᵢₖ}_{≥0)}(aᵢₖ)

H_{B}(B)=Σⱼₖδ_{(b}_{ⱼₖ}_{≥0)}(bⱼₖ) (1-7)

The expression (1-7) is subject to the following condition.

$$\begin{matrix}[ Math . 7 ] & \\ {δ}_{( {a}_{ik} \geq 0 )} ( {a}_{ik} ) = \{ \begin{matrix}0 & ( {a}_{ik} \geq 0 ) \\ + ∞ & ( otherwise )\end{matrix} & \\ {δ}_{( {b}_{jk} \geq 0 )} ( {b}_{jk} ) = \{ \begin{matrix}0 & ( {b}_{jk} \geq 0 ) \\ + ∞ & ( otherwise )\end{matrix} & \end{matrix}$$

(0≤I≤I, 0≤j≤J, 0≤k≤K) is satisfied.

Further, assuming that the matrix {A, B} has sparsity as a probabilistic characteristic of the matrix {A, B}, a normalization term represented by the following expressions using an L1-norm can also be used.

[Math. 8]

H_{A}(A)=Σᵢₖ(δ₍ₐ_{ᵢⱼ}_{≥0)}(aᵢₖ)+μ_{A}|aᵢₖ|)μ_{A}>0 (1-8)

H_{B}(B)=Σⱼₖ(δ_{(b}_{ⱼₖ}_{≥0)}(bⱼₖ)+μ_{B}|bⱼₖ|)μ_{B}>0 (1-9)

μ_{A} and μ_{B} are (positive) constants given in advance.

Next, a description is given of an algorithm for optimizing non-negative matrix factorization, which is used to solve the above-mentioned non-negative matrix factorization problem. Here, an optimization algorithm based on a multiplicative update rule (NPL 1) and an optimization algorithm based on an alternating direction method of multipliers (ADMM) (NPL 2) are described.

First, a description is given of the optimization algorithm based on the multiplicative update rule. The multiplicative update rule can be represented as a type of a forward gradient method, and is constructed by processing of subtracting, from a current component, an amount obtained by multiplying the gradient of the cost function J by a step size n.

[Math. 9]

aᵢₖ←aᵢₖ−ηᵢₖ∂ₐ_{ᵢₖ}J(A,B) (1-10)

bⱼₖ←bⱼₖ−ηⱼₖ∂_{b}_{ⱼₖ}J(A,B) (1-11)

For example, when the @ divergence of the expression (1-6) is used as the loss term, the gradient of the cost function J is given by the following expressions.

$$\begin{matrix}[ Math . 10 ] & \\ {\partial }_{{a}_{ik}} J ( A , B ) = {\sum }_{j = 1}^{J} ( {y}_{ij} / {[ {AB}^{T} ]}_{ij}^{1 - β} ) {b}_{jk} - {\partial }_{{a}_{ik}} {H}_{A} ( A ) & \text{(1-12)} \\ {\partial }_{{b}_{jk}} J ( A , B ) = {\sum }_{i = 1}^{I} ( {y}_{ij} / {[ {AB}^{T} ]}_{ij}^{1 - β} ) {a}_{ik} - {\partial }_{{b}_{jk}} {H}_{B} ( B ) & \text{(1-13)}\end{matrix}$$

Step sizes ηᵢₖ and ηⱼₖ are defined by the following expressions.

$$\begin{matrix}[ Math . 11 ] & \\ {η}_{ik} = {a}_{ik} / {\sum }_{j = 1}^{J} {[ {AB}^{T} ]}_{ij}^{β} {b}_{jk} & \\ {η}_{jk} = {b}_{jk} / {\sum }_{i = 1}^{I} {[ {AB}^{T} ]}_{ij}^{β} {a}_{ik} & \end{matrix}$$

Then, the expressions (1-10) and (1-11) are represented in the following manner.

$$\begin{matrix}[ Math . 12 ] & \\ {a}_{ik} ← {a}_{ik} \frac{{[ {\sum }_{j = 1}^{J} ( {y}_{ij} / {[ {AB}^{T} ]}_{ij}^{1 - β} ) {b}_{jk} - {\partial }_{{a}_{ik}} {H}_{A} ( A ) ]}_{+}}{{\sum }_{j = 1}^{J} {[ {AB}^{T} ]}_{ij}^{β} {b}_{jk} + ɛ} & \text{(1-14)} \\ {b}_{jk} ← {b}_{jk} \frac{{[ {\sum }_{i = 1}^{I} ( {y}_{ij} / {[ {AB}^{T} ]}_{ij}^{1 - β} ) {a}_{ik} - {\partial }_{{b}_{jk}} {H}_{B} ( B ) ]}_{+}}{{\sum }_{i = 1}^{I} {[ {AB}^{T} ]}_{ij}^{β} {a}_{ik} + ɛ} & \text{(1-15)}\end{matrix}$$

In the above expressions, [z]₊=max{z, 0} is defined, and ε (>0) is a constant.

Therefore, the optimization algorithm based on the multiplicative update rule inputs the measurement matrix Y, and calculates the matrix {A, B} by updating the matrix {A, B} a predetermined number of times using the expressions (1-14) and (1-15). A matrix E representing a noise can also be calculated by using the expression (1-1).

Next, a description is given of the optimization algorithm based on the ADMM. A method described below has a format of the cost function different from that of NPL 2, resulting in a difference in format of the algorithm. However, both the methods are intrinsically equivalent to each other.

An important idea of this algorithm is to replace a matrix product AB^{T} included in the loss term of the expression (1-2) with an auxiliary variable Z to handle a constrained convex minimization problem.

$$\begin{matrix}[ Math . 13 ] & \\ \begin{matrix}{inf}_{{Z \geq 0}_{A \geq 0 , B \geq 0}} G ( Y ‖ Z ) + {H}_{Z} ( Z ) + {H}_{A} ( A ) + {H}_{B} ( B ) \\ s . t . Z = {AB}^{T}\end{matrix} & \text{(1-16)}\end{matrix}$$

A Lagrange function L associated with the expression (1-16) is defined by the following expression.

[Math. 14]

L(Z,A,B,U)=G(Y∥Z)+H_{Z}(Z)+H_{A}(A)+H_{B}(B)+ [symbol] U,Z−AB^{T} [symbol] (1-17)

UϵR^{I×J} is a dual variable. Further, <U, Z>=tr(U^{T}Z) is defined.

In this case, when a dual problem is to be solved (instead of the main problem), the non-negative matrix factorization problem is formulated as an optimization problem of the following expression.

$$\begin{matrix}[ Math . 15 ] & \\ {sup}_{U} {inf}_{{Z \geq 0}_{A \geq 0 , B \geq 0}} L ( Z , A , B , U ) & \text{(1-18)}\end{matrix}$$

The expression (1-18) represents an operation of estimating matrices Z, A, B that produce an infimum of the Lagrange function L and then estimating a dual variable U that produces a supremum of the Lagrange function L for the estimated matrices Z, A, B.

The optimization algorithm based on the ADMM to solve the problem of the expression (1-18) is shown in FIG. 1 and FIG. 2. The optimization algorithm of FIG. 1 and the optimization algorithm of FIG. 2 are equivalent to each other. Further, variables {^{˜}X, ^{˜}V} that appear in the optimization algorithms of FIG. 1 and FIG. 2 are variables that are obtained by subjecting the dual variable U to non-linear transformation. The expressions in the algorithms are simplified by using the variables {^{˜}X, ^{˜}V}. κ (>0) is a constant representing the step size. The optimization algorithms of FIG. 1 and FIG. 2 both input the measurement matrix Y, and calculate the matrix {A, B} by updating the matrix {A, B} a predetermined number of times.

### CITATION LIST

### Non Patent Literature

[NPL 1] D. D. Lee and H. S. Seung, “Learning the parts of objects by non-negative matrix factorization”, Nature, Vol. 401, No. 6755, pp. 788-791, 1999.
[NPL 2] D. L. Sun and C. Fevotte, “Alternating direction method of multipliers for non-negative matrix factorization with the beta-divergence”, in IEEE International Conference on Acoustics, Speech and Signal Processing (ICASSP) 2014. IEEE, pp. 6201-6205, 2014.

### SUMMARY OF THE INVENTION

### Technical Problem

The optimization algorithm based on the multiplicative update rule has an advantage of having an extremely simple update rule and being implemented easily. In addition, the optimization algorithm based on the multiplicative update rule also has an advantage of achieving extremely fast convergence speed and a low calculation amount per step at an initial stage of update. However, it is reported that, as the number of times of update has increased to approach a fixed point (namely, solution minimizing cost function), the convergence rate of an error becomes lower (refer to NPL 2). In other words, there is a problem in that the optimization algorithm based on the multiplicative update rule has a difficulty in approaching a solution with a high estimation accuracy and a low convergence speed.

Meanwhile, an experiment has shown that the convergence rate of an error of the optimization algorithm based on the ADMM does not tend to become lower easily even when the number of times of update has increased (refer to NPL 2). However, it is reported that it is necessary to determine in advance the step size (K in algorithms of FIG. 1 and FIG. 2) required for update, and the effect cannot be obtained when the step size is not set appropriately. In other words, there is a problem in that the optimization algorithm based on the ADMM sometimes has a difficulty in approaching a solution with a high estimation accuracy, for example, when the step size is not set appropriately, with the result that convergence is not stable.

In view of the above, the present invention has an object to provide a non-negative matrix factorization technology that achieves high-speed and stable convergence.

### Means for Solving the Problem

According to one aspect of the present invention, there is provided a non-negative matrix factorization optimization device including an optimization unit configured to optimize a non-negative matrix {A, B}, which is factorization of a matrix Z satisfying Z=AB^{T}, by inputting a measurement matrix Y, where Y represents a non-negative measurement matrix representing a measurement signal or measurement data, and Z represents a non-negative matrix constructing the measurement matrix Y, and a cost function J to be used for optimization by the optimization unit is defined by an expression of J(A, B)=G(Y|AB^{T})+H_{A}(A)+H_{B}(B), where G represents a loss term, H_{A} represents a normalization term for the matrix A, and H_{B} represents a normalization term for the matrix B, and the optimization unit optimizes the matrix {A, B} based on Bregman monotone operator splitting.

### Effects of the Invention

According to the present invention, it is possible to achieve non-negative matrix factorization representing a non-negative matrix as a product of two non-negative matrices stably at a high speed.

### BRIEF DESCRIPTION OF DRAWINGS

FIG. 1 is a diagram illustrating an example of an optimization algorithm based on an ADMM.

FIG. 2 is a diagram illustrating an example of the optimization algorithm based on the ADMM.

FIG. 3 is a diagram illustrating an example of an optimization algorithm (B-P-R type) according to an embodiment of the present invention.

FIG. 4 is a diagram illustrating an example of an optimization algorithm (B-D-R type) according to an embodiment of the present invention.

FIG. 5 is a block diagram illustrating a configuration of a non-negative matrix factorization optimization device 100.

FIG. 6 is a flow chart illustrating an operation of the non-negative matrix factorization optimization device 100.

FIG. 7 is a block diagram illustrating a configuration of an optimization unit 110.

FIG. 8 is a flow chart illustrating an operation of the optimization unit 110.

### DESCRIPTION OF EMBODIMENTS

Now, a description is given in detail of an embodiment of the present invention. A component having the same function is assigned with the same reference numeral, and a redundant description thereof is omitted.

Prior to the description of each embodiment, a notation rule in this specification is described.

\hat{ } (caret) represents a superscript. For example, x^{y\hat{ }z} represents the fact that y^{z} is a superscript of x, and x_{y\hat{ }z} represents the fact that y^{z} is a subscript of x. Further, _ (underscore) represents a subscript. For example, x^{y_z} represents the fact that y_{z} is a superscript of x, and x_{y_z} represents the fact that y_{z} is a subscript of x.

The superscript ‘^{\hat{ }}’ or ‘^{˜}’ used as ^{\hat{ }}x or ^{˜}x for a certain character x is originally considered to be written right above ‘x’, but ^{\hat{ }}x or ^{˜}x is written due to restriction of notation in specification.

### TECHNICAL BACKGROUND

The ADMM uses Douglas-Rachford monotone operator splitting. Further, as described above, in the optimization algorithm based on the ADMM, it is necessary to set in advance a predetermined parameter such as a step size appropriately.

Considering the above-mentioned two points, an optimization algorithm according to an embodiment of the present invention is constructed as an optimization algorithm that is based on the optimization algorithm based on the ADMM and achieves high-speed and stable convergence. Specifically, the optimization algorithm according to an embodiment of the present invention is constructed as an optimization algorithm that (1) removes the necessity for adjusting a parameter such as a step size, and (2) also enables use of Peaceman-Rachford monotone operator splitting.

First, a description is given of a theory behind the optimization algorithm according to an embodiment of the present invention. The dual problem represented by the expression (1-18) can be handled as a problem of minimizing a sum of convex conjugate functions (closed proper convex function) by transforming the expression in the following manner.

$$\begin{matrix} [ Math . 16 ] & \\ {sup}_{U} {inf}_{{Z \geq 0}_{A \geq 0 , B \geq 0}} L ( Z , A , B , U ) = {sup}_{U} [ - {sup }_{Z \geq 0} ( - 〈 U , Z 〉 - G ( Y ‖ Z ) - {H}_{Z} ( Z ) ) - {sup}_{A \geq 0 , B \geq 0} ( - 〈 U , {AB}^{T} 〉 - {H}_{A} ( A ) - {H}_{B} ( B ) ) ] = - {inf}_{U} [ {G}^{*} ( - U ) + {H}^{*} ( U ) ] & \text{(2-1)}\end{matrix}$$

In the above expression, G* and H* are each a convex conjugate function (closed proper convex function) represented by the following expressions.

$$\begin{matrix}[ Math . 17 ] & \\ {G}^{*} ( - U ) = {sup}_{Z \geq 0} ( - 〈 U , Z 〉 - G ( Y ‖ Z ) - {H}_{Z} ( Z ) ) & \text{(2-2)} \\ {H}^{*} ( U ) = {sup}_{A \geq 0 , B \geq 0} ( 〈 U , {AB}^{T} 〉 - {H}_{A} ( A ) - {H}_{B} ( B ) ) & \text{(2-3)}\end{matrix}$$

The fixed point of the expression (2-1) is obtained when a sum of subderivatives of the convex conjugate functions {G*, H*} includes a zero matrix as represented by the following expression.

[Math. 18]

0∈T₁(U)+T₂(U) (2-4)

In the above expression, Tᵢ:R^{I×J}→R^{I×J} (i=1, 2) represents a subdifferential operator of the convex conjugate functions {G*, H*}. In other words, the following expressions are obtained.

T₁(U)=−∂G*(−U)

T₂(U)=∂H*(U) [Math. 19]

Tᵢ serves as a monotone operator that inputs an I×J matrix and outputs an I×J matrix.

A main idea for removing the necessity for adjusting a parameter is to automatically correct measurement of a variable space by adapting to a convex function. An operator ∇D⁻¹ for realizing this idea is introduced. The function D:R^{I×J}→R^{I×J} is a (continuously differentiable and strongly convex) proper convex function, and it is assumed that a differential operator ∇D:R^{I×J}→R^{I×J} and an inverse operator ∇D⁻¹:R^{I×J}→R^{I×J} thereof satisfy the following expression.

[Math. 20]

∇D(0)=0,∇D⁻¹(0)=0 (2-5)

The method of automatically correcting measurement of the variable space by adapting to the convex function is described later in detail.

When the function D satisfies the expression (2-5), ∇D⁻¹ is applied to both sides of the expression (2-4), which is a condition for the fixed point, to obtain the following expression.

[Math. 21]

0∈∇D⁻¹·T₁(U)+∇D⁻¹·T₂(U) (2-6)

In the above expression, · represents a composite of operators. Thus, in the expression (2-6), ∇D⁻¹ and Tᵢ are combined with each other.

When the expression (2-6) is transformed in accordance with Reference Non-Patent Literature 1, two types of monotone operator splitting, namely, Bregman Peaceman-Rachford (B-P-R)-type monotone operator splitting of the expression (2-7) and Bregman Douglas-Rachford (B-D-R)-type monotone operator splitting of the expression (2-8) are obtained.

[Math. 22]

X∈C_{T}_{₂}·C_{T}_{₁}(X) (2-7)

X∈ξC_{T}_{₂}·C_{T}_{₁}(X)+(1−ξ)X (2-8)

In the above expressions, XϵR^{I×J} represents an auxiliary variable of the dual variable U and represents an averaging coefficient of an averaging operator. Any number that satisfies ξϵ(0, 1) can be used as ξ, but ½ is used in many cases. (Reference Non-Patent Literature 1: K. Niwa and W. B. Kleijn, “Bregman monotone operator splitting”, arXiv preprint arXiv:1807.04871, 2018.)

As can be understood from the expression (2-7) and the expression (2-8), (B-D-R)-type monotone operator splitting is obtained by applying an averaging operator to the (B-P-R)-type monotone operator splitting, and thus the (B-P-R)-type monotone operator splitting is predicted to converge at a higher speed.

When a recursive variable update rule is derived from the expression (2-7) and the expression (2-8), such update processing as represented by expressions (2-9) to (2-13) is derived.

$$\begin{matrix} [ Math . 23 ] & \\ U ← {R}_{1} ( X ) = {( I + ∇ {D}^{- 1} ∘ {T}_{1} )}^{- 1} ( X ) & \text{(2-9)} \\ V ← {C}_{1} ( X ) = 2 U - X & \text{(2-10)} \\ W ← {R}_{2} ( V ) = {( I + ∇ {D}^{- 1} ∘ {T}_{2} )}^{- 1} ( V ) & \text{(2-11)} \\ X ← \{ \begin{matrix}{C}_{2} ( V ) = 2 W - V & \text{(2-12)} \\ {ξC}_{2} ( V ) + ( 1 - ξ ) X = ξ ( 2 W - V ) + ( 1 - ξ ) X & \text{(2-13)}\end{matrix} & \end{matrix}$$

The expressions (2-9) to (2-12) are (B-P-R)-type variable update rules derived from the expression (2-7), and the expressions (2-9) to (2-11) and the expression (2-13) are (B-D-R)-type variable update rules derived from the expression (2-8).

The expressions (2-9) to (2-13) include, for example, a subdifferential operator Tᵢ of the convex conjugate function, and thus the expression is transformed further. First, the expression (2-9) is transformed so as to update the main variable and the dual variable alternatively. A problem associated with the convex conjugate function G* (refer to expression (2-2)) included in the expression (2-9) is defined by the following expression.

$$\begin{matrix}[ Math . 24 ] & \\ {inf}_{Z} G ( Y ‖ Z ) + {H}_{Z} ( Z ) s . t . Z = 0 & \end{matrix}$$

The Lagrange function Q of the above-mentioned problem is defined by the following expression.

Q(Z,U)=G(Y∥Z)+H_{Z}(Z)+<U,Z> [Math. 25]

The variables {Z, U} are updated such that the subderivative of the Lagrange function Q includes a zero vector.

∂(G(Y∥Z)+H_{Z}(Z))=T₁⁻¹(Z) [Math. 26]

This results in the following expression.

0∈T₁⁻¹(Z)−U⇔Z∈T₁(U) [Math. 27]

When the relationship between the variable Z and the variable U is used, the following expressions are satisfied for input/output variables {U, X} of a resolvent operator R₁ of the expression (2-9).

U∈R₁(X)

(I+∇D⁻¹·T₁)(U)∈X

U+∇D⁻¹(Z)=X,0∈T₁⁻¹(Z)−U [Math. 28]

Those expressions are transformed to obtain the following expression.

0∈T₁⁻(Z)+∇D⁻¹(Z)−X [Math. 29]

This is equivalent to solving the following expression.

$$\begin{matrix}[ Math . 30 ] & \\ Z ← a r g {min}_{Z \geq 0} ( G ( Y ‖ Z ) + {H}_{Z} ( Z ) - 〈 U , Z 〉 + ∇ {D}^{- 1} ( Z ) ) & \end{matrix}$$

The variable U is also updated by using the updated variable Z.

U←X−∇D⁻¹(Z) [Math. 31]

The expression (2-10) and the above-mentioned expression are combined and the variable U is removed to obtain an update rule of a dual auxiliary variable V.

V←X−2∇D⁻¹(Z) [Math. 32]

The following dual auxiliary variables {^{˜}V, ^{˜}X} are introduced to simplify the expression.

V=∇D⁻¹(\tilde{V})

X=∇D⁻¹(\tilde{X}) [Math. 33]

When the dual auxiliary variables {^{˜}V, ^{˜}X} are used, the expression (2-9 2-10) are represented by the following expressions.

$$[ Math . 34 ]$$

$$\begin{matrix}Z ← arg {min}_{Z \geq 0} ( G ( Y \vert \vert Z ) + {H}_{Z} ( Z ) + {B}_{{D}^{+}} ( Z \vert \vert \tilde{X} ) ) & ( 2 \text{-} 14 ) \\ \tilde{V} ← \tilde{X} - 2 Z & ( 2 \text{-} 15 )\end{matrix}$$

The Bregman divergence B_{D\hat{ }+} is a proper convex function that corrects measurement of the variable space, and is given by the following expression.

B_{D}_{⁺}(Z∥\tilde{X})=D⁺(Z)−D⁺(\tilde{X})−<∇D⁻¹(\tilde{X}),Z−\tilde{X}> [Math. 35]

Similarly, the expressions (2-11) to (2-13) are represented by the following expressions.

$$[ Math . 36 ]$$

$$\begin{matrix}A ← arg {min}_{A \geq 0} ( {H}_{A} ( A ) + {B}_{{D}^{+}} ( {AB}^{T} \vert \vert - \tilde{V} ) ) & ( 2 \text{-} 16 ) \\ B ← arg {min}_{B \geq 0} ( {H}_{B} ( B ) + {B}_{{D}^{+}} ( {AB}^{T} \vert \vert - \tilde{V} ) ) & ( 2 \text{-} 17 ) \\ \tilde{X} ← \{ \begin{matrix}\tilde{V} + 2 {AB}^{T} \\ ξ \tilde{X} + ( 1 - ξ ) ( \tilde{V} + 2 {AB}^{T} )\end{matrix} & \begin{matrix}( 2 \text{-} 18 ) \\ ( 2 \text{-} 19 )\end{matrix}\end{matrix}$$

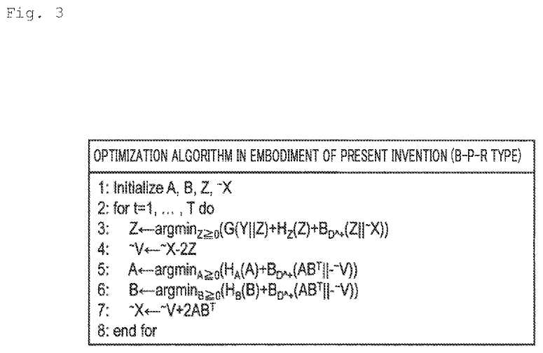

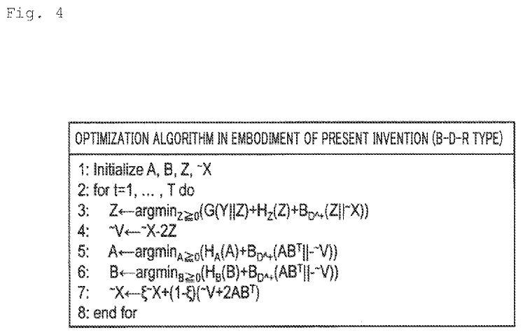

The expressions (2-14) to (2-19) are expressions that construct the variable update rule of the optimization algorithm of an embodiment of the present invention. FIG. 3 and FIG. 4 represent the (B-P-R)-type optimization algorithm and the (B-D-R)-type optimization algorithm, respectively.

Lastly, a description is given of a method of designing a proper convex function D⁺ for achieving high-speed convergence without adjusting a parameter. Specifically, a description is given of a method of adaptively correcting the function D⁺ in accordance with a convex function G. A generalized quadratic form represented by the following expression is used as one implementation method. In order to reduce the calculation amount, a cost that ignores a correlation between matrix components as in the case of the expression (1-4) is assumed.

[Math. 37]

D⁺(Z)=½Σᵢⱼ(hᵢⱼ+ε)zᵢⱼ² (2-20)

In the above expression, z_{i,j} represents an (i, j) component of the matrix Z. ε (>0) is a sufficiently small constant, and is used to ensure that the function D is a proper convex function.

Further, ∇D⁺(0)=0 is satisfied, and thus it is efficient to design hᵢⱼ so as to follow the secondary gradient of the function G as in the following expression.

[Math. 38]

hᵢⱼ=∇ᵢⱼ²G(zᵢⱼ^{old}) (2-21)

zᵢⱼ^{old} represents an (i, j) component of the current matrix Z.

At this time, the function D that has a differential operator inverse to that of the function D⁺ is given by the following expression.

$$[ Math . 39 ]$$

$$D ( Z ) = \frac{1}{2} {Σ}_{ij} \frac{1}{{h}_{ij} + ɛ} {z}_{ij}^{2} \qquad ( 2 \text{-} 22 )$$

In order to further reduce the calculation amount and achieve high-speed convergence, hᵢⱼ may be set to be an (i, j) component of a matrix H represented by the following expression.

[Math. 40]

H=h_{A}h_{B}^{T} (2-23)

In the above expression, h_{A}ϵR^{I} and h_{B}ϵR^{J} are satisfied.

The expression (2-23) represents the fact that (I×J) matrix components are represented by (I+J) vector components, and contributes to suppression of the memory amount in addition to update of the variable at a higher speed.

The vectors {h_{A}, h_{B}} can be determined by using an average value of secondary gradients of a predetermined number of functions G, for example.

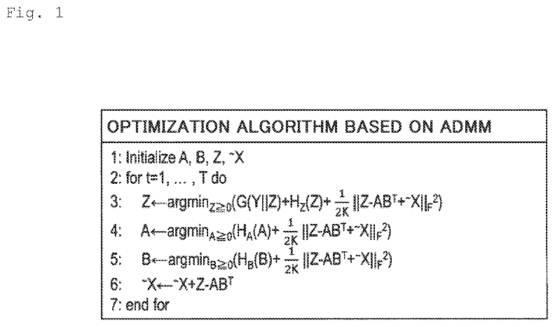

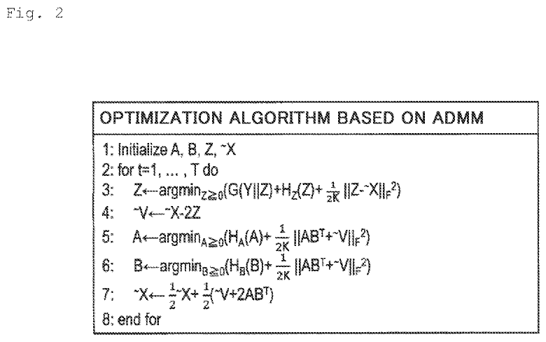

Although specific experimental data is not shown in this description, it is confirmed that the convergence speed of the matrix {A, B} and the estimation accuracy of the matrix {A, B} are both improved by using the optimization algorithms of FIG. 3 and FIG. 4 compared to the conventional optimization algorithm (e.g., optimization algorithms of FIG. 1 and FIG. 2). In particular, it is confirmed that the (B-P-R)-type optimization algorithm of FIG. 3 has a large effect.

### First Embodiment

Y represents a non-negative measurement matrix representing a measurement signal or measurement data, and Z represents a non-negative matrix constructing the measurement matrix Y satisfying the expression (1-1). A non-negative matrix factorization optimization device 100 inputs the measurement matrix Y, and optimizes the non-negative matrix {A, B}, which is factorization of the matrix Z satisfying Z=AB^{T}.

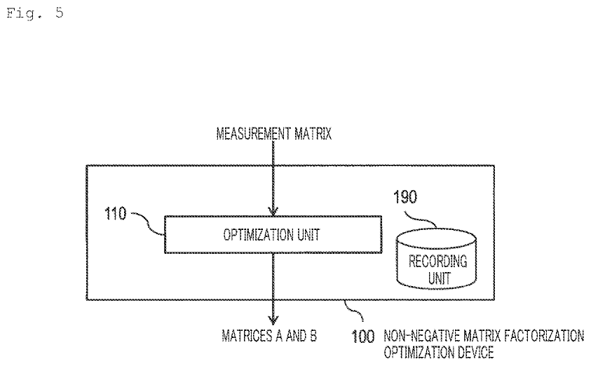

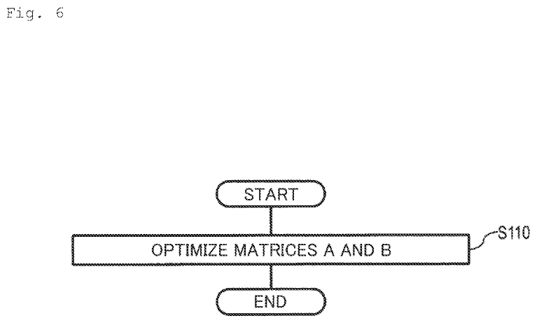

Now, a description is given of the non-negative matrix factorization optimization device 100 with reference to FIG. 5 and FIG. 6. FIG. 5 is a block diagram illustrating a configuration of the non-negative matrix factorization optimization device 100. FIG. 6 is a flow chart illustrating an operation of the non-negative matrix factorization optimization device 100. As illustrated in FIG. 5, the non-negative matrix factorization optimization device 100 includes an optimization unit 110 and a recording unit 190. The recording unit 190 is a component configured to appropriately record information necessary for processing of the non-negative matrix factorization optimization device 100. The recording unit 190 records, for example, the measurement matrix Y to be input and the matrix {A, B} to be optimized.

Now, a description is given of an operation of the non-negative matrix factorization optimization device 100 with reference to FIG. 6.

In S110, the optimization unit 110 inputs the measurement matrix Y, and optimizes the matrix {A, B}, which is factorization of the matrix Z satisfying Z=AB^{T}. Specifically, the optimization unit 110 inputs the measurement matrix Y, and solves the minimization problem of the cost function J to optimize the matrix {A, B}. The cost function J(A, B):R^{I×K}×R^{J×K}→R∪{−∞, +∞} is defined by the following expression.

J(A,B)=G(Y∥AB^{T})+H_{A}(A)+H_{B}(B) [Math. 41]

(In the above expression, G represents a loss term, H_{A} represents a normalization term for the matrix A, and H_{B} represents a normalization term for the matrix B)

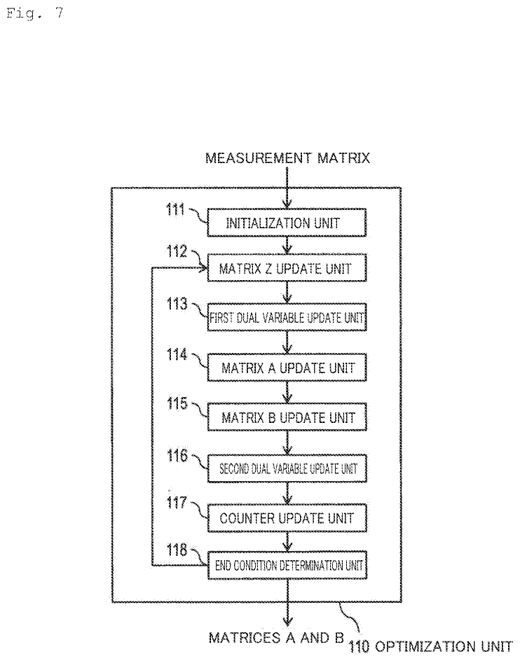

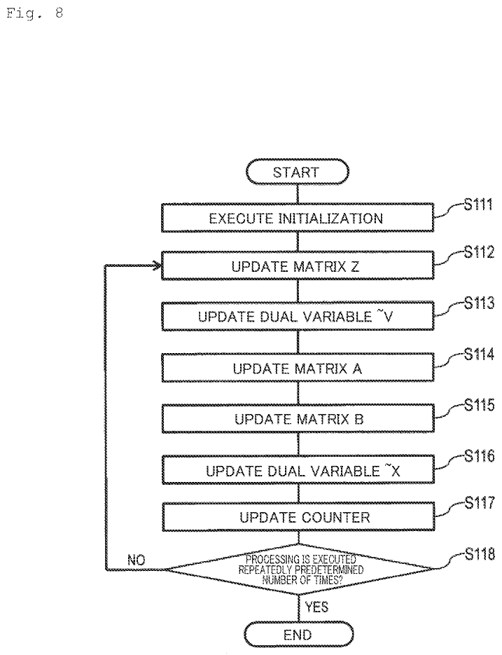

Now, a description is given of the optimization unit 110 with reference to FIG. 7 and FIG. 8. FIG. 7 is a block diagram illustrating a configuration of the optimization unit 110. FIG. 8 is a flow chart illustrating an operation of the optimization unit 110. As illustrated in FIG. 7, the optimization unit 110 includes an initialization unit 111, a matrix Z update unit 112, a first dual variable update unit 113, a matrix A update unit 114, a matrix B update unit 115, a second dual variable update unit 116, a counter update unit 117, and an end condition determination unit 118.

Now, a description is given of an operation of the optimization unit 110 with reference to FIG. 8.

In S111, the initialization unit 111 initializes a counter t. Specifically, t=1 is set. Further, the initialization unit 111 initializes the matrix A, the matrix B, the matrix Z, and the dual variable ^{˜}X.

In S112, the matrix Z update unit 112 updates the matrix Z in accordance with the following expression.

$$[ Math . 42 ]$$

$$Z ← arg {min}_{Z \geq 0} ( G ( Y \vert \vert Z ) + {H}_{Z} ( Z ) + {B}_{{D}^{+}} ( Z \vert \vert \tilde{X} ) )$$

(H_{Z} represents a normalization term for the matrix Z, and B_{D\hat{ }+} represents a Bregman divergence defined by using the function D⁺)

The function D⁺ used for defining the Bregman divergence B_{D\hat{ }+} is given by the following expression.

D⁺(C)=½Σᵢⱼ(hᵢⱼ+ε)cᵢⱼ² [Math. 43]

(C represents a matrix having cᵢⱼ as an (i, j) component, hᵢⱼ=∇ᵢⱼ²G(cᵢⱼ^{old}) (cᵢⱼ^{old} represents an (i, j) component of the current matrix C is defined, and ε (>0) represents a predetermined constant.) Further, the function D⁺ may be calculated by using the vectors h_{A} and h_{B} satisfying H=h_{A}h_{B}^{T} for the matrix H having hᵢⱼ as an (i, j) component. When the function D⁺ is calculated, Z or ^{˜}X is used.

The matrix A update unit 114 and the matrix B update unit 115 also use this function D⁺. In this case, when the function D⁺ is calculated, AB^{T} or −^{˜}V is used.

In S113, the first dual variable update unit 113 updates the dual variable ^{˜}V in accordance with the following expression.

\tilde{V}←\tilde{X}−2Z [Math. 44]

In S114, the matrix A update unit 114 updates the matrix A in accordance with the following expression.

$$[ Math . 45 ]$$

$$A ← arg {min}_{A \geq 0} ( {H}_{A} ( A ) + {B}_{{D}^{+}} ( {AB}^{T} \vert \vert - \tilde{V} ) )$$

In S115, the matrix B update unit 115 updates the matrix B in accordance with the following expression.

$$[ Math . 46 ]$$

$$B ← arg {min}_{B \geq 0} ( {H}_{B} ( B ) + {B}_{{D}^{+}} ( {AB}^{T} \vert \vert - \tilde{V} ) )$$

In S116, the second dual variable update unit 116 updates the dual variable ^{˜}X in accordance with the following expression.

\tilde{X}←\tilde{V}+2AB^{T} [Math. 47]

In S117, the counter update unit 117 increments the counter t by 1. Specifically, t←t+1 is set.

In S118, when the counter t has reached a predetermined update count T (T represents an integer equal to or larger than 1, for example, one hundred thousand) (that is, t>T is satisfied and the end condition is satisfied), the end condition determination unit 118 outputs the matrix {A, B} at that time, and finishes the processing. Otherwise, the processing returns to the processing of S112. In other words, the optimization unit 110 repeats the processing of from S112 to S118.

The processing of S114 and S115 (namely, update processing of the matrix A and update processing of the matrix B) may be executed in order of S114 and S115, or may be executed in order of S115 and S114. Further, S114 and S115 may be executed in parallel.

### MODIFICATION EXAMPLE

In the above, the second dual variable update unit 116 updates the dual variable ^{˜}X in accordance with the (B-P-R)-type update rule, but may update the dual variable ^{˜}X in accordance with the (B-D-R)-type update rule. In this case, in S116, the second dual variable update unit 116 updates the dual variable ^{˜}X in accordance with the following expression.

\tilde{X}←ξ\tilde{X}+(1−ξ)(\tilde{V}+2AB^{T}) [Math. 48]

(In the above expression, ξ represents a constant satisfying 0<ξ<1)

As described above, in summary, the optimization unit 110 optimizes the matrix {A, B} based on the Bregman monotone operator splitting.

According to the embodiment of the present invention, it is possible to achieve non-negative matrix factorization representing a non-negative matrix as a product of two non-negative matrices stably at a high speed. Further, the function D⁺ is corrected adaptatively in accordance with the convex function G. Thus, measurement of the variable space can be corrected adaptatively, and adjustment of a parameter (e.g., step size) necessary for the optimization algorithm based on the conventional ADMM is removed.

<Supplementary Note>

The device according to this invention includes, as one hardware entity, for example, an input unit to which a keyboard or the like can be connected, an output unit to which a liquid crystal display or the like can be connected, a communication unit to which a communication device (e.g., communication cable) capable of communicating with the outside of the hardware entity can be connected, a central processing unit (CPU, which may include a cache memory or a register, for example), a RAM or ROM being a memory, an external storage device being a hard disk, and a bus connecting the input unit, the output unit, the communication unit, the CPU, the RAM, the ROM, and the external storage device to one another so as to enable exchange of data. Further, as the necessity arises, a device (drive) capable of reading/writing data from/to a storage medium such as a CD-ROM may be provided in the hardware entity. A physical entity including such hardware resources is, for example, a general computer.

The external storage device of the hardware entity stores, for example, a program necessary for implementing the above-mentioned function and data necessary for processing of this program (instead of the external storage device, a ROM being a read-only storage device may store the program, for example). Further, data or the like obtained by processing of the program is appropriately stored in a RAM or external storage device, for example.

In the hardware entity, each program stored in the external storage device (or ROM or the like) and data necessary for processing of each program are read into the memory as necessary, and are appropriately interpreted, executed, and processed by the CPU. As a result, the CPU implements a predetermined function (each component represented by unit, means, or the like in the above description).

The present invention is not limited to the above-mentioned embodiments, and can be modified appropriately without departing from the gist of the present invention. Further, the processing described in the above-mentioned embodiments may not always be executed chronologically in order of description, but may be executed in parallel or individually depending on the necessity or the processing capability of a device configured to execute processing.

As described above, when a computer implements the processing functions of the hardware entity (device according to present invention) described in the above-mentioned embodiments, the details of processing of functions to be included in the hardware entity are described in a program. Then, the computer executes the program, so that the processing functions of the hardware entity are implemented on the computer.

The program describing the details of processing can be recorded in a computer-readable storage medium. The computer-readable storage medium may be, for example, any medium such as a magnetic storage device, an optical disc, a magneto-optical recording medium, or a semiconductor memory. Specifically, for example, a hard disk drive, a flexible disc, a magnetic tape, or the like can be used as the magnetic storage device. A digital versatile disc (DVD), a DVD-random access memory (RAM), a compact disc read only memory (CD-ROM), a CD-recordable (R)/rewritable (RW), or the like can be used as the optical disc. A magneto-optical disc (MO) or the like can be used as the magneto-optical recording medium. An electronically erasable and programmable-read only memory (EEP-ROM) or the like can be used as the semiconductor memory.

Further, the program is distributed by, for example, selling, transferring, or lending a portable storage medium such as a DVD or CD-ROM recording the program. Further, a configuration may be adopted, in which the program is stored in a storage device of a server computer, and the program is distributed by transferring the program from the server computer to other computers.

A computer that executes such a program first temporarily stores, into an own recording device, a program recorded in the portable storage medium or a program transferred from the server computer, for example. Then, at the time of execution of processing, the computer reads the program stored in the own recording device, and executes processing in accordance with the read program. Further, as another execution mode of the program, the computer may directly read a program from the portable storage medium, and execute processing in accordance with the program. Further, every time the server computer transfers a program to the computer, the computer may sequentially execute processing in accordance with the received program. Further, the server computer may not transfer a program to the computer, but may be configured to execute the above-mentioned processing by a so-called application service provider (ASP) service, which implements processing functions by simply giving an execution command and obtaining a result. The program in this mode is information to be provided for processing by an electronic computational machine, and includes data (e.g., data with property specifying processing of a computer without directly giving a command to the computer) equivalent to a program.

Further, in this mode, the hardware entity is configured by executing a predetermined program on a computer. However, at least a part of details of the processing may be implemented by hardware.

Description of the above-mentioned embodiments of the present invention is given for the purpose of exemplification and description. The description is not intended to be exhaustive, and the invention is not intended to be limited to the exact disclosed format. Modification or variation can be made based on the above-mentioned teaching. The embodiments are selected and represented to provide most appropriate exemplification of the principle of the present invention, and to enable a person skilled in the art to use the present invention in the form of various embodiments or by adding various modifications thereto so as to adapt to considered actual usage. All such modifications and variations fall within the scope of the present invention defined by the appended claims interpreted in accordance with a range given fairly, legally, and equally.

1. A non-negative matrix factorization optimization device, the device comprising:
an optimizer configured to optimize a non-negative matrix {A, B} which is factorization of a matrix Z satisfying Z=AB^{T}, by inputting a measurement matrix Y, where Y represents a non-negative measurement matrix representing a measurement signal or measurement data, and Z represents a non-negative matrix constructing the measurement matrix Y, wherein a cost function J to be used for optimization by the optimizer is defined by the following expression:
J(A,B)=G(Y∥AB^{T})+H_{A}(A)+H_{B}(B), [Math. 49]
where G represents a loss term, H_{A} represents a normalization term for the matrix A, and H_{B} represents a normalization term for the matrix B, wherein the optimizer comprises: a matrix Z updater configured to update the matrix Z in accordance with the following expression:
$$[ Math . 50 ]$$
$$Z ← arg {min}_{Z \geq 0} ( G ( Y \vert \vert Z ) + {H}_{Z} ( Z ) + {B}_{{D}^{+}} ( Z \vert \vert \tilde{X} ) ) ,$$
where H_{Z} represents a normalization term for the matrix Z, and B_{D\hat{ }+} represents a Bregman divergence defined by using the function D*; a first dual variable updater configured to update a dual variable ^{˜}V in accordance with the following expression:
\tilde{V}←\tilde{X}−2Z; [Math. 51]
a matrix A opdater configured to update the matrix A in accordance with the following expression:
$$[ Math . 45 ]$$
$$A ← arg {min}_{A \geq 0} ( {H}_{A} ( A ) + {B}_{{D}^{+}} ( {AB}^{T} \vert \vert - \tilde{V} ) ) ;$$
a matrix B updater configured to update the matrix B in accordance with the following expression:
$$[ Math . 46 ]$$
$$B ← arg {min}_{B \geq 0} ( {H}_{B} ( B ) + {B}_{{D}^{+}} ( {AB}^{T} \vert \vert - \tilde{V} ) ) ;$$
a second dual variable updater configured to update the dual variable ^{˜}X in accordance with the following expression:
\tilde{X}←\tilde{V}+2AB^{T}. [Math. 54]

2. A non-negative matrix factorization optimization device, the device comprising:
an optimizer configured to optimize a non-negative matrix {A, B}, which is factorization of a matrix Z satisfying Z=AB^{T}, by inputting a measurement matrix Y, where Y represents a non-negative measurement matrix representing a measurement signal or measurement data, and Z represents a non-negative matrix constructing the measurement matrix Y, wherein a cost function J to be used for optimization by the optimize is defined by the following expression:
J(A,B)=G(Y∥AB^{T})+H_{A}(A)+H_{B}(B), [Math. 55]
where G represents a loss term, H_{A} represents a normalization term for the matrix A, and H_{B} represents a normalization term for the matrix B, wherein the optimizer comprises: a matrix Z updater configured to update the matrix Z in accordance with the following expression:
$$[ Math . 56 ]$$
$$Z ← arg {min}_{Z \geq 0} ( G ( Y \vert \vert Z ) + {H}_{Z} ( Z ) + {B}_{{D}^{+}} ( Z \vert \vert \tilde{X} ) ) ,$$
where H_{Z} represents a normalization term for the matrix Z, and B_{D\hat{ }+} represents a Bregman divergence defined by using the function D⁺; a first dual variable updater configured to update a dual variable ^{˜}V in accordance with the following expression:
\tilde{V}←\tilde{X}−2Z; [Math. 57]
a matrix A updater configured to update the matrix A in accordance with the following expression:
$$[ Math . 58 ]$$
$$A ← arg {min}_{A \geq 0} ( {H}_{A} ( A ) + {B}_{{D}^{+}} ( {AB}^{T} \vert \vert - \tilde{V} ) ) ;$$
a matrix B updater configured to update the matrix B in accordance with the following expression:
$$[ Math . 59 ]$$
$$B ← arg {min}_{B \geq 0} ( {H}_{B} ( B ) + {B}_{{D}^{+}} ( {AB}^{T} \vert \vert - \tilde{V} ) ) ;$$
and
a second dual variable updater configured to update the dual variable ^{˜}X in accordance with the following expression:
\tilde{X}←ξ\tilde{X}+(1−ξ)(\tilde{V}+2AB^{T}), [Math. 60]
where ξ represents a constant satisfying 0<ξ<1.

3. The non-negative matrix factorization optimization device according to claim 1, wherein the function D⁺ to be used for defining the Bregman divergence B_{D\hat{ }+}, which is used by the matrix Z updater, the matrix A updater, and the matrix B updater, is represented by the following expression:
D⁺(C)=½Σᵢⱼ(hᵢⱼ+ε)cᵢⱼ², [Math. 61]
where C represents a matrix having cᵢⱼ as an (i, j) component, hᵢⱼ=∇ᵢⱼ²G(cᵢⱼ^{old})(cᵢⱼ^{old} represents an (i, j) component of the current matrix C) is defined, and ε(>0) represents a predetermined constant.

4. The non-negative matrix factorization optimization device according to claim 3, wherein the function D⁺ is calculated by using vectors h_{A} and h_{B} satisfying H=h_{A}h_{B}^{T} for a matrix H having hᵢⱼ as an (i, j) component.

5. A non-negative matrix factorization optimization method, the method comprising:
of optimizing, by a non-negative matrix factorization optimization device, a non-negative matrix {A, B}, which is factorization of a matrix Z satisfying Z=AB^{T}, by inputting a measurement matrix Y, where Y represents a non-negative measurement matrix representing a measurement signal or measurement data, and Z represents a non-negative matrix constructing the measurement matrix Y, wherein a cost function J to be used for the optimizing is defined by the following expression:
J(A,B)=G(Y∥AB^{T})+H_{A}(A)+H_{B}(B), [Math. 62]
where G represents a loss term, H_{A} represents a normalization term for the matrix A, and H_{B} represents a normalization term for the matrix B, wherein the optimizing further comprises: a matrix Z update step of updating the matrix Z in accordance with the following expression:
$$[ Math . 63 ]$$
$$Z ← arg {min}_{Z \geq 0} ( G ( Y \vert \vert Z ) + {H}_{Z} ( Z ) + {B}_{{D}^{+}} ( Z \vert \vert \tilde{X} ) )$$
where H_{Z} represents a normalization term for the matrix Z, and B_{D\hat{ }+} represents a Bregman divergence defined by using the function D⁺; a first dual variable update step of updating a dual variable ^{˜}V in accordance with the following expression:
\tilde{V}←\tilde{X}−2Z; [Math. 64]
a matrix A update step of updating the matrix A in accordance with the following expression:
$$[ Math . 65 ]$$
$$A ← arg {min}_{A \geq 0} ( {H}_{A} ( A ) + {B}_{{D}^{+}} ( {AB}^{T} \vert \vert - \tilde{V} ) ) ;$$
a matrix B update step of updating the matrix B in accordance with the following expression:
$$[ Math . 66 ]$$
$$B ← arg {min}_{B \geq 0} ( {H}_{B} ( B ) + {B}_{{D}^{+}} ( {AB}^{T} \vert \vert - \tilde{V} ) ) ;$$
a second dual variable update step of updating the dual variable ^{˜}X in accordance with the following expression:
\tilde{X}←\tilde{V}+2AB^{T}. [Math. 67]

6.-7. (canceled)

8. The non-negative matrix factorization optimization device according to claim 2, wherein the function D⁺ to be used for defining the Bregman divergence B_{D\hat{ }+}, which is used by the matrix Z updater, the matrix A updater, and the matrix B updater, is represented by the following expression:
D⁺(C)=½Σᵢⱼ(hᵢⱼ+ε)cᵢⱼ², [Math. 61]
where C represents a matrix having cᵢⱼ as an (i, j) component, hᵢⱼ=∇ᵢⱼ²G(cᵢⱼ^{old})(cᵢⱼ^{old} represents an (i, j) component of the current matrix C) is defined, and ε(>0) represents a predetermined constant.

9. The non-negative matrix factorization optimization device according to claim 8, wherein the function D⁺ is calculated by using vectors h_{A} and h_{B} satisfying H=h_{A}h_{B}^{T} for a matrix H having hᵢⱼ as an (i, j) component.

10. The non-negative matrix factorization optimization method according to claim 5, wherein the function D⁺ to be used for defining the Bregman divergence B_{D\hat{ }+}, which is used by the matrix Z updater, the matrix A updater, and the matrix B updater, is represented by the following expression:
D⁺(C)=½Σᵢⱼ(hᵢⱼ+ε)cᵢⱼ², [Math. 61]
where C represents a matrix having cᵢⱼ as an (i, j) component, hᵢⱼ=∇ᵢⱼ²G(cᵢⱼ^{old})(cᵢⱼ^{old} represents an (i, j) component of the current matrix C) is defined, and ε(>0) represents a predetermined constant.

11. The non-negative matrix factorization optimization method according to claim 10, wherein the function D⁺ is calculated by using vectors h_{A} and h_{B} satisfying H=h_{A}h_{B}^{T} for a matrix H having hᵢⱼ as an (i, j) component.
